(19) United States
(12) Patent Application Publication
(10) Pub. No.: US 2015/0218895 A1
(43) Pub. Date: Aug. 6, 2015

(54) SYSTEM AND METHOD FOR AUTOMATED ROD CHANGING

(71) Applicant: ATLAS COPCO NORTH AMERICA, LLC, Garland, TX (US)

(72) Inventors: Mahmood Hassan, Garland, TX (US); Tim Ledbetter, Garland, TX (US)

(73) Assignee: ATLAS COPCO NORTH AMERICA, LLC, Garland, TX (US)

(21) Appl. No.: 14/173,063

(22) Filed: Feb. 5, 2014

(51) Int. Cl. E21B 19/16; E21B 44/00; G05B 15/02; E21B 15/00

(52) U.S. Cl. CPC E21B 19/165; E21B 15/00; E21B 44/00; G05B 15/02

(57) ABSTRACT

A system for automated drilling rod changing has an upper position sensor capable of sensing the position of the rotary head with respect to the deck, and a lower position sensor also capable of sensing the position of the rotary head with respect to the deck. The position sensors have respective electrical outputs connected to a computer. The computer is programmed to compute the vertical position of the rotary head with respect to the deck at a first position, where a first rod is suspended above a second rod held by the table clamp, and at a second position, where the box end of the first rod is capable of being connected to the pin end of the second rod, based on the computed position of the rotary head; and, the computer is programmed to command the rotary head to move from the first position to the second position.

### BACKGROUND

1. Technical Field

The present application relates to apparatus and systems for connecting well tubulars together to be run down hole; more particularly to apparatus and systems for detecting and managing the location of the drilling rig rotary head or top drive relative to drilling rods or tubulars to be engaged, so as to allow automated rod changing.

2. Background

In connecting together a series of individual casing segments or other tubulars, such as drill rods, and running the assembled string down a well or blast hole, each tubular is typically first lifted up into the rig derrick structure. The lower end of each suspended tubular is then added to the tubular string by threadedly connecting the lower end of the suspended tubular to the upper end of the string at a point of connection near the rig floor. During the connecting operation, the upper end of the assembled string is typically held by a rotary table, table clamp, or other gripping device located on the rig floor such that the remainder of the string is suspended in the well or blast hole being drilled. When the connection is completed, the gripping device at the rig floor is released in order to allow the newly attached section to be lowered into the well or blast hole. Once lowered, the upper end of the added section is then gripped at the rig floor by the rotary gripping device so that the next tubular section can then be lifted into the derrick and threadedly connected to the assembled string.

A prior art system comprises a rig floor or drilling platform; a rotary table system or other gripping device which holds the upper end of the assembled string; a derrick structure; a suspended traveling block and swivel assembly, typically carrying a rotary head or “top drive” motor, which can be operated for lifting, suspending, and lowering additional tubular segments within the derrick; and a stabbing apparatus positioned within derrick for stabbing the suspended tubular section, which may be a drill rod. As used herein, the term “stabbing” refers to the operation of stabilizing, positioning, aligning, or otherwise directing the lower end of the suspended tubular segment (the female “box end”) into engagement with the upper end of the tubular string (the male “pin end”) for connecting the lower end of the tubular segment to the upper end of the tubular string. Unless otherwise distinguished, in this application and the claims, the terms “rod” and “tubular” are synonymous and include pipe, casing and drilling rod.

Increasingly, drillers are using rotary head or “top drive” systems. A top drive is a drilling tool that hangs from the traveling block, and has one or more motors to power a drive shaft to which crewmembers attach the drill string. Because the unit's motor can rotate the drill string, no Kelly or Kelly bushing is required. The top drive unit incorporates a spinning capability. The spinning capability is used to thread the rotary head into the box end of a tubular and unthread the rotary drive from the box end of a tubular. This allows the rotary drive to connect to, and raise and lower tubulars.

It is desirable that the operation of a drilling rig be automated to the extent possible, to increase drilling productivity, avoid the cross-threading of sections during stabbing, and to avoid accidents arising from the presence of human workers on the rig floor.

For completion and operation of different wells, different equipment is sometimes necessary within the well bore and at the surface of the well. Such equipment is used for drill rod handling, pressure control, tubing work, casing handling, and well installation. Traditionally, such equipment has been manually operated. Currently, the industry trend is toward mechanization and automation of such equipment where possible.

For example, mechanized rig systems improve rig flow operations by helping operators install tubing, casing, and drilling rods more safely and efficiently during demanding drilling operations. Such a mechanized rig system reduces the time needed for pipe handling, make-up, and break out of pipe connections.

Other mechanized equipment for well bores includes tongs, like tubing tongs, basing tongs, and drill pipe tongs for making up tubular connections. There are also tongs used in systems for placing a predetermined torque on a connection as well as tongs having independent rotation devices disposed therein. Additionally, some tongs include maneuvering devices that may be rail mounted are designed to suspend casing, tubing or drill type tongs from a frame.

In addition to the foregoing description, devices are routinely further automated and mechanized through the use of sensors for controlling and monitoring equipment and also for monitoring parameters of such equipment, like temperature, pressure, fluid flow, and torque, for example.

According to known methods for controlling or monitoring such a parameter, a corresponding sensor is generally connected to a measuring device which is part of or at least directly connected to some kind of computer terminal. The data from the sensor is transmitted to such measuring device and from this to the computer terminal. The measuring device comprises for example, a micro-controller with customized software that may be used for collecting the data from the sensor and to transmitting it to the computer terminal. At the computer terminal, the data is processed and then displayed as a graphical display, as a bar graph, for example. An example of such a computerized drilling system is the Atlas Copco Rig Control System (RCS) from Atlas Copco Rock Drills, AB.

In such an automated system, it is particularly important therefore, that the location of the box end of the tubular suspended from the rotary drive be known as accurately as possible with respect to the stabbing end of the tubular suspended in the well bore (not shown) to avoid mis-threading or cross-threading or to avoid incomplete threading or unthreading. Since the length of tubulars used in drilling is standardized, this implies that the position of the rotary head connected to the tubular be known as accurately as possible. Prior-art systems typically use the output of a rotary encoder connected to the pulley sheave, but because of cable stretching and mounting variables, this rarely gives an accuracy of better than about 15 cm. What is needed is a way to locate the position of the rotary head accurately and in real time, so that the operations of adding or removing tubulars, particularly drill rods, from a drill string can be efficiently and safely automated.

### DRAWINGS

FIG. 1 is a perspective view of a typical drilling rig with an embodiment installed on it.

FIG. 2 is a detail perspective view of an embodiment of an upper sensor.

FIG. 3 is a detail perspective view of an embodiment of a lower sensor.

FIG. 4 is a detail side view of the mounting of an embodiment of a lower sensor.

FIG. 5 is a detail side view of the mounting of an embodiment of a lower sensor, showing also a position of a rotary head with respect to the sensor.

FIG. 6 is a further detail of the mounting of an embodiment of a sensor.

FIG. 7 is a top view of the relationship between an embodiment of the magnet and sensor relationship.

FIG. 8 is a perspective view of an embodiment of the magnet and holder therefore.

FIG. 9 is a functional block diagram of the control system of an embodiment.

### DETAILED DESCRIPTION

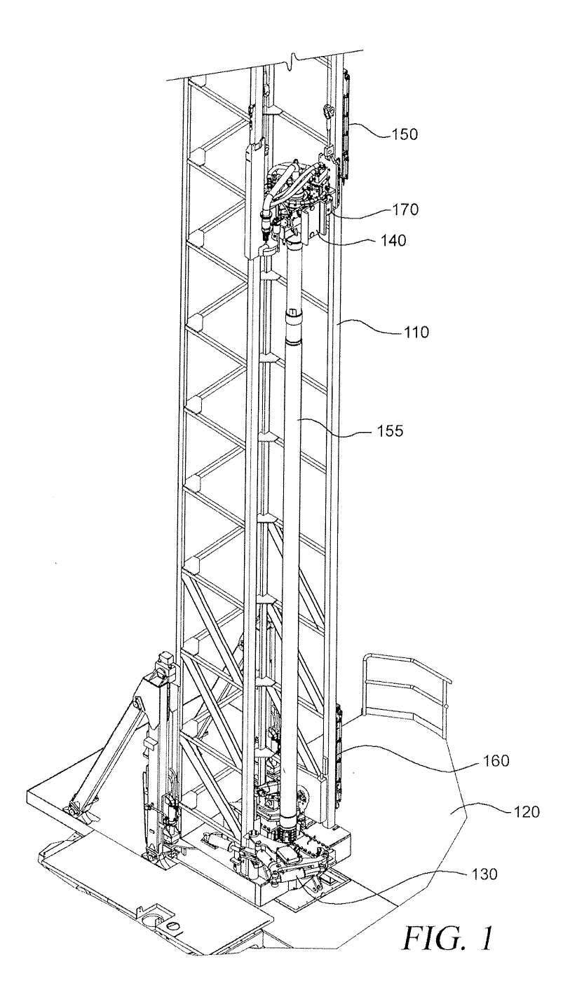

FIG. 1 depicts a typical drilling rig (100) comprising a derrick structure (110) mounted above a deck (120). An automated break-out wrench system (130) at the deck level performs the make-up and break-up of rod sections (155), an example of which (155) is shown in FIG. 1. The derrick (110) supports a rotary head (140), typically a hydraulic motor having elevators (not shown) for grasping and holding the tubular (155). Rod sections (155) may be brought onto the rig from internal or external carousels (not shown) or off-rig loaders, as is known in the art.

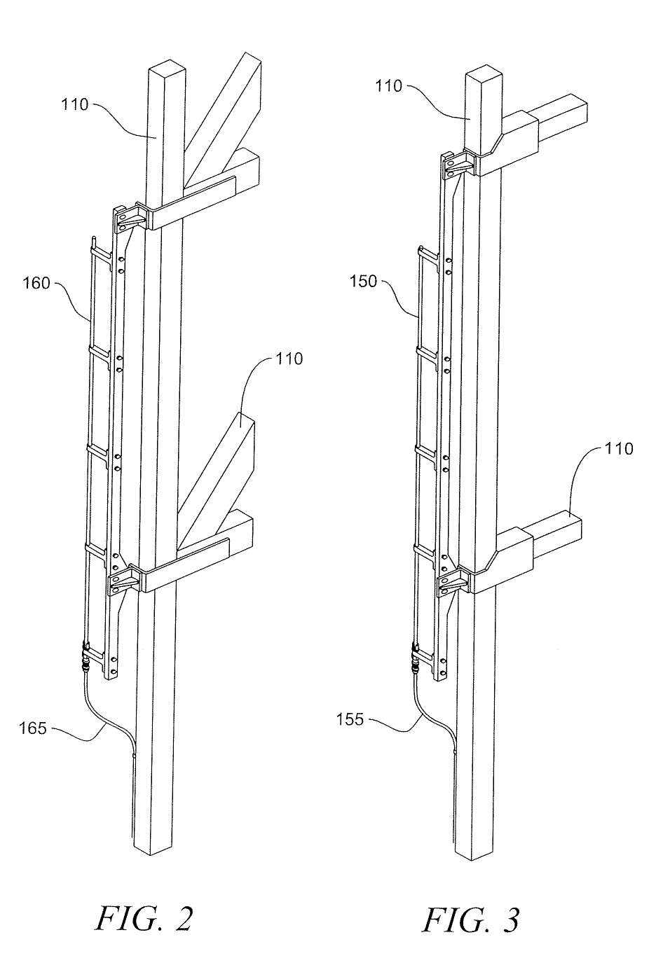

FIGS. 2 and 3 show the location of an upper sensor (150) and a lower sensor (160) for sensing the position of the rotary head (140) relative to the derrick (110) and therefore the deck (120), a break-out wrench system (130) and a table clamp (135).

FIG. 2 shows the upper sensor (150) of a preferred embodiment in more detail, and FIG. 3 shows a corresponding lower sensor (160). The upper sensor (150) and the lower sensor (160) are preferably extended rods containing Hall-effect magnetic detection devices. Such a sensor is available from Rota Engineering, Ltd. of Manchester, U.K. Such sensors can provide a spatial resolution of approximately 0.5 mm. These sensors have a built-in microprocessor that can provide a proportional voltage, current, PWM or CANBUS output. In the embodiment here, a 4-20 ma current loop is preferred for input to the RCS. In the embodiment shown, the sensors (150, 160) are mounted to the derrick (110) by upper and lower brackets (180, 190) that hold the long axis of the sensors (150, 160) substantially parallel to the derrick (110) structure.

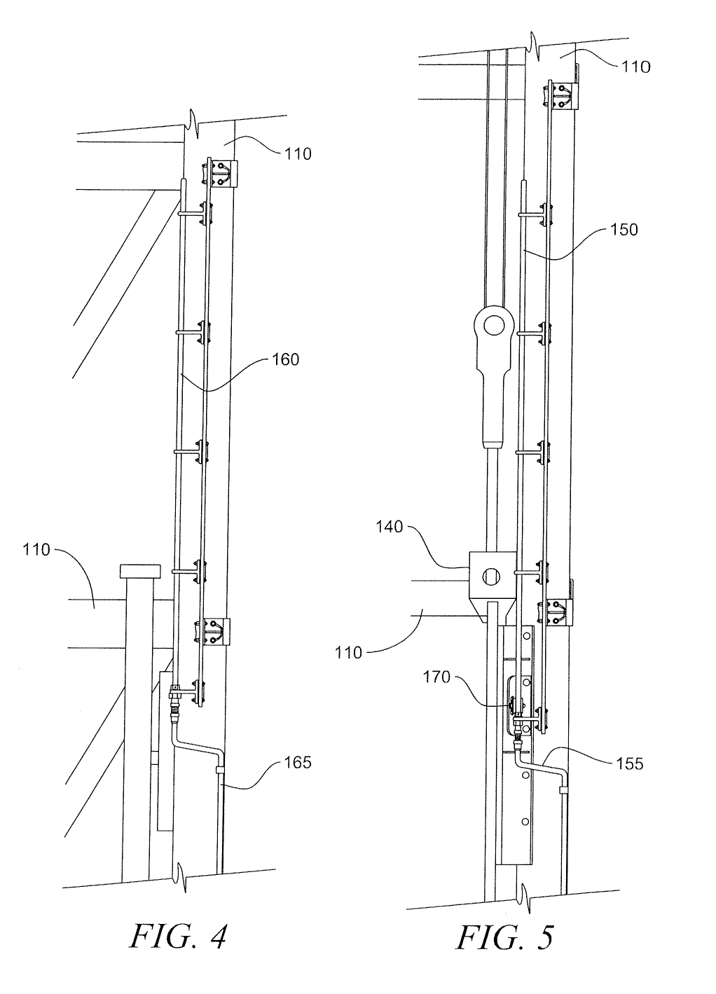

FIG. 4 is a side view of the preferable mounting of the lower sensor (160). FIG. 5 is a side view of a preferable mounting of the upper sensor (150), showing it with respect to the moving vertical location of the rotary head (140), as well as the magnet (170) moving with the rotary head (140).

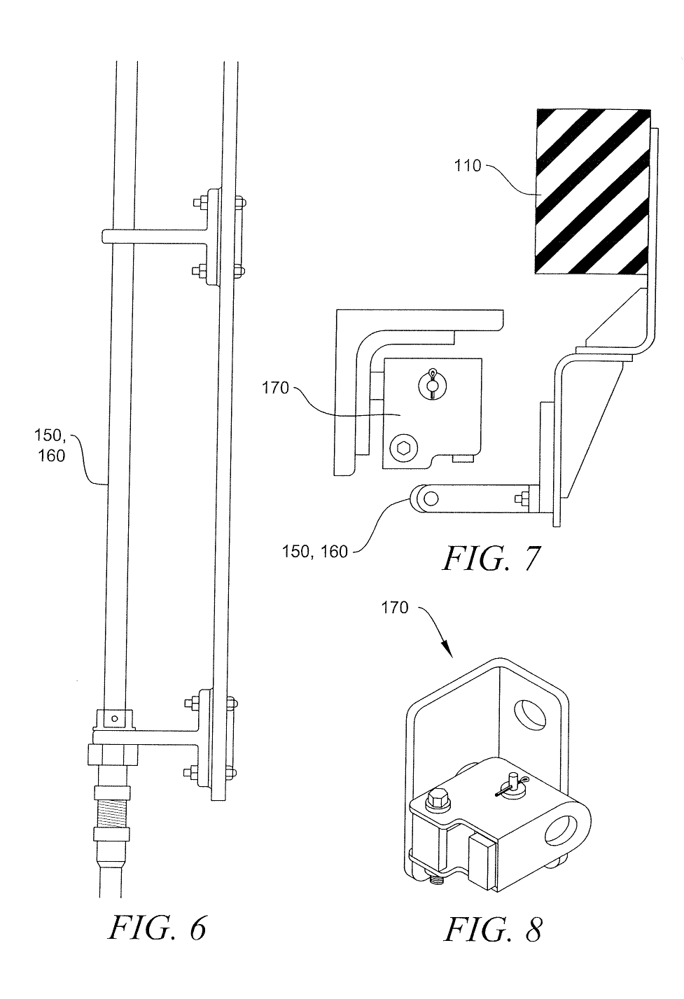

FIG. 6 is a detailed view of the position sensor (150, 160) mounting, and FIGS. 7 and 8 show preferred mounting details of the magnet (170) with respect to the derrick structure (110) and the sensors (150, 160).

The preferred magnetic sensors (150, 160) detect a magnetic field from a magnet (170) mounted to the rotary head (140) of the rig (100). A suitable magnet is manufactured by Rota Engineering, Ltd. The magnet (170) is mounted so that it maintains substantially the same distance from the sensors (150) and (160) as the rotary head (140) moves up and down with respect to the derrick (110) structure. Typically, the distance between the magnet (170) and a sensor would be approximately 20 mm, although this distance will depend on the strength of the magnet (170) chosen and the sensitivity of the sensors (150, 160), as well as to accommodate allowable wear on the guides of the rotary head (140).

Because the location of the magnet (170) on the rotary head (140) is known accurately, the position of the rotary head (140) may be calculated accurately by software running in the RCS (200). Appropriate signal lines (210, 220) connect the outputs of the sensors (150, 160) to the RCS.

A shown in FIGS. 2 and 3, the sensors (150, 160) are mounted to the derrick structure (110) by an upper bracket (180) and a lower bracket (190). The magnet (170) may be mounted to the rotary head (140) by a suitable bracket (230), as shown in FIG. 4.

In another embodiment, if a rod sensor is available that extends substantially the full length of the derrick (110), then either the upper sensor (150) or the lower sensor (160) may be a single extended sensor, and the other sensor omitted. In such a case, the disclosed system operates as described above, except that the location of the rotary head (140) is calculated from the position of the magnet (170) along the single extended sensor.

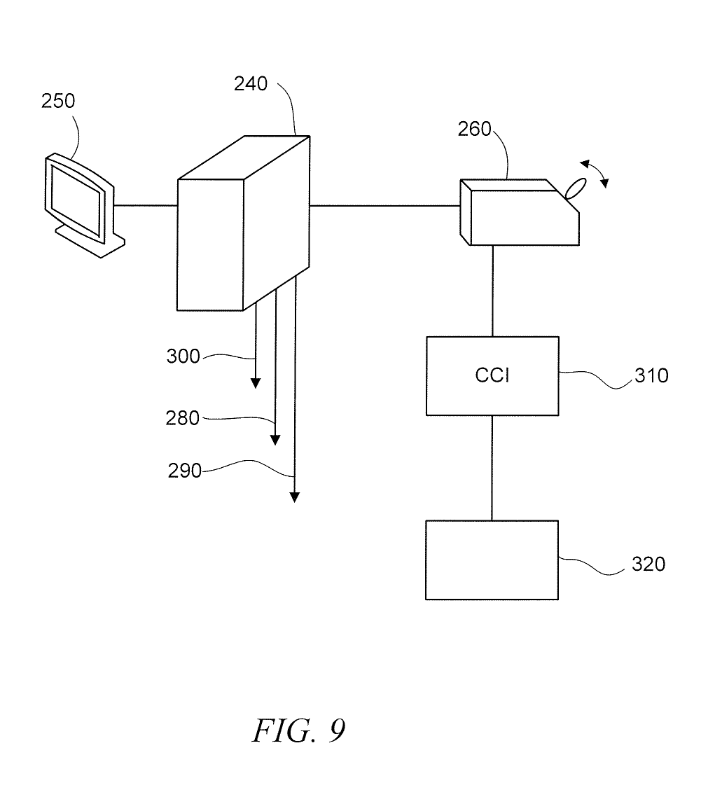

In an exemplary automated control system, a computer (240) is provided in the drilling rig as a part of the RCS for controlling the operations of the drilling rig. The computer preferably has a display (250) with a graphical user interface, and an operator's control console (260). The computer (240) ensures a secure and reliable functioning of the remote control of the drilling rig. A CAN (Controller Area Network) bus (270) is preferably used for the transfer of data between the computer (240) and its peripherals and other devices and actuators on the rig (100). A CAN bus (270) is a two-wire serial bus, suitable for use in particularly exposed environments, for example in noisy environments having considerable interference, such as in drilling operations. The CAN bus (270) is connected to the computer system (240), lines (280, 290) to the upper and lower sensors (150, 160) and lines (300) controlling various actuators handling rig operations, as shown in FIG. 9. Such actuators include the motors or hydraulics controlling the movement of the table clamp, power tongs, and top drive position and rotation.

The computer (240) is typically a programmable digital computer comprising a read-only memory, and a random-access memory for holding a stored program, a central-processing unit, and a hard drive for further storage of programs and data, as well as input-output ports.

The computer (240) is in turn preferably connected to a signal converter, or a Common Communication Interface (CCI) (310) able to handle Ethernet communication in the event it is desired to operate the RCS from a remote location with controls connected to an Ethernet network (320). The construction and configuration of Ethernet networks is well known in the art. The CCI interface (310) then converts the data from the CAN bus (270) into a format usable within the Ethernet network (320). An optional control center (not shown), from where an operator could remotely control the drilling rig, would also be provided with a CCI interface, where the data is converted back to a CAN bus traffic format, and provided to the operator by means of an operator panel (not shown).

In summary therefore, we disclose a system for automated drilling rod changing, where the system comprises a derrick (110), a deck (120), a table clamp (135), a rotary head (140), and a programmable computer (240) having a stored program. The system operates with rods having opposing box ends and pin ends.

An upper position sensor (150) is capable of sensing the position of the rotary head (140) with respect to the deck (120), and a lower position sensor (160) is also capable of sensing the position of the rotary head (140) with respect to the deck (120). The lower position sensor is (160) located on the derrick (110) below the upper position sensor (150). The upper and lower position sensors (150, 160) have respective electrical outputs (210, 220); the respective electrical outputs (210, 220) being connected to the computer (240).

The computer (240) is programmed to compute the vertical position of the rotary head (140) with respect to the deck (120) at a first position, where a first rod is suspended above a second rod held by the table clamp (135), and at a second position, where the box end of the first rod is capable of being connected to the pin end of the second rod, based on the electrical outputs (210, 220) of the upper position sensor (150) and the lower position sensor (160); and, the computer (240) is programmed to command the rotary head (140) to move from the first position to the second position.

We claim:

1. A system for automated drilling rod changing, where the system comprises a derrick, a deck, a table clamp, a rotary head, and a programmable computer having a stored program; the system operating with rods having opposing box ends and pin ends;
the system further comprising:
an upper position sensor, the upper position sensor capable of sensing the position of the rotary head with respect to the deck;
a lower position sensor, the lower position sensor capable of sensing the position of the rotary head with respect to the deck;
the lower position sensor located on the derrick below the upper position sensor;
the upper and lower position sensors having respective electrical outputs; the respective electrical outputs connected to the computer;
the computer programmed to compute the vertical position of the rotary head with respect to the deck at a first position, where a first rod is suspended above a second rod held by the table clamp, and at a second position, where the box end of the first rod is capable of being connected to the pin end of the second rod, based on the electrical outputs of the upper position sensor and the lower position sensor; and,
the computer programmed to command the rotary head to move from the first position to the second position.

2. The system of claim 1, where the computer is further programmed to command the rotary head to lower and rotate to make up a joint between the first rod and the second rod.

3. The system of claim 2, where the computer is further programmed to command the table clamp to release the connected first and second rods after the joint is made up.

4. The system of claim 3, where the computer is further programmed to command the vertical position of the rotary head to move from the second position to a third position where the connected first and second rods are lowered until the pin end of the first rod can be clamped by the table clamp.

5. The system of claim 4 where the computer is further programmed to command the rotary head to disengage from the first rod and move from the third position to a fourth position above the deck, such that a third rod may be connected to the rotary head, where the box end of the third rod is suspended above the pin end of the clamped second rod.

6. A system for automated drilling rod changing, where the system comprises a derrick, a deck, a table clamp, a rotary head, and a programmable computer having a stored program; the system operating with rods having opposing box ends and pin ends; the system further comprising:
an upper position sensor, the upper position sensor capable of sensing the position of the rotary head with respect to the deck;
a lower position sensor, the lower position sensor capable of sensing the position of the rotary head with respect to the deck;
the lower position sensor located on the derrick below the upper position sensor;
the upper and lower position sensors having respective electrical outputs; the respective electrical outputs connected to the computer;
the computer programmed to compute the vertical position of the rotary head with respect to the deck at a first position where the rotary head is connected to the box end of a first rod held by the table clamp, and at a second position, where the first rod is raised so that the pin end of a second rod connected to the first rod can be clamped by the table clamp, based on the electrical outputs of the upper position sensor and the lower position sensor; and,
the computer programmed to command the rotary head to move from the first position to the second position.

7. The system of claim 6, where the first rod is connected to the second rod at a joint, and where the computer is further programmed to command the rotary head to break the joint between the first rod and the second rod.

8. The system of claim 7, where the computer is further programmed to command the rotary head, when the first rod has been removed from the rotary head and when the second rod has been clamped by the table clamp, from the second position to a third position;
where in the third position, the rotary head is positioned so that the rotary head may be threaded into the pin end of second rod.

9. The system of claim 8, where the computer is further programmed to command the rotary head to connect to the pin end of the second rod.

10. The system of claim 9, where the computer is further programmed to command the table clamp to release the second rod, and to command the rotary head to move from the third position to a fourth position, where the pin end of the second rod is suspended at the table clamp.

11. A system for automated drilling rod changing, where the system comprises a derrick, a deck, a table clamp, a rotary head, and a programmable computer having a stored program; the system operating with rods having opposing box ends and pin ends;
the system further comprising:
an single position sensor, the single position sensor capable of sensing the position of the rotary head with respect to the deck;
the single position sensor having an electrical output; the electrical output connected to the computer;
the computer programmed to compute the vertical position of the rotary head with respect to the deck at a first position, where a first rod is suspended above a second rod held by the table clamp, and at a second position, where the box end of the first rod is capable of being connected to the pin end of the second rod, based on the electrical output of the single position sensor; and,
the computer programmed to command the rotary head to move from the first position to the second position.

12. The system of claim 11, where the computer is further programmed to command the rotary head to lower and rotate to make up a joint between the first rod and the second rod.

13. The system of claim 12, where the computer is further programmed to command the table clamp to release the connected first and second rods after the joint is made up.

14. The system of claim 13, where the computer is further programmed to command the vertical position of the rotary head to move from the second position to a third position where the connected first and second rods are lowered until the pin end of the first rod can be clamped by the table clamp.

15. The system of claim 14 where the computer is further programmed to command the rotary head to disengage from the first rod and move from the third position to a fourth position above the deck, such that a third rod may be connected to the rotary head, where the box end of the third rod is suspended above the pin end of the clamped second rod.
